(19) United States
(12) Patent Application Publication
(10) Pub. No.: US 2002/0143956 A1
(43) Pub. Date: Oct. 3, 2002

(54) Relay server

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/114,963

(22) Filed: Apr. 2, 2002

(30) Foreign Application Priority Data
Apr. 3, 2001 (JP) 2001-104381
Jul. 16, 2001 (JP) 2001-215298

(51) Int. Cl. G06F 15/16

(52) U.S. Cl. 709/227

(57) ABSTRACT

A relay server for realizing the connection between the device of the Internet side and the terminal within the local system, and capable of identifying each connection, even in the case a plurality of connections exist between each of the network apparatus and the relay server. When a first terminal logs into the relay server 4, the connection identifier 1 that is unique within the relay system is assigned to the connection 1, and is returned. As in the same manner, when a second terminal logs into the relay server, the connection identifier 2 that is unique within the relay system is assigned to the connection 2, and is returned. The communication between the first and second terminals is realized, by the relay server 4 relaying the communication by using connections 1 and 2.

### CROSS REFERENCES TO RELATED APPLICATIONS

This application claims priority under 35 USC 119 of Japanese Patent Application Nos. 2001-104381, and 2001-215298 filed in JPO on Apr. 3, 2001, and Jul. 16, 2001, respectively, the entire disclosures of which are incorporated herein by reference.

### BACKGROUND OF THE INVENTION

1. Field of the Invention

The present invention relates to a relay server for carrying out communication with a plurality of network devices, or carrying out the communication further with another relay server or other relay servers, and realizing the communication between the network device(s) and another network device or other relay servers.

2. Description of the Related Art

FIG. 13 is an illustration of an example of a general system using the Internet. In FIG. 13, reference numerals 1, 2 designate local systems, 3 the Internet, 11, 12, 21, 22 terminals, 13, 23 gateways, and 14, 24 LANs (Local Area Network). The terminal 11, the terminal 12, the gateway 13, and the like are connected by the LAN 14 to form the local system 1. The gateway 13 is connected to the Internet 3 along with the LAN 14, and the Internet can be used from various network apparatus, such as the terminal 11 or the terminal 12 on the LAN 14. Moreover, the local system 2 is formed in the same manner, and the terminal 21, the terminal 22, the gateway 23 and the like are connected by the LAN 24 to form the local system 2. The gateway 23 is connected to the Internet 3 along with the LAN 24, and the Internet can be used from various network apparatus, such as the terminal 21, and the terminal 22 on the LAN 24. Moreover, other various apparatus can be connected by the LAN 14 within the local system 1, and by the LAN 24 within the local system 2. (A network apparatus is also referred to as a network device in the present specification.)

According to such a system, normally, one or a plurality of global IP addresses are assigned to the local system 1 and the local system 2, but a global IP address is not assigned to each of the network apparatus within the local system 1 and the local system 2. A private IP address is assigned to each network apparatus within each of the local system 1 and the local system 2. The gateways 13 and 23 use functions such as NAT (Network Address Translation) and IP masquerade so as to convert a private IP address into a global IP address. By using the gateway 13 and the gateway 23 having such functions for converting the IP address, for example, in the local system 1, the terminal 11 and the terminal 12 use the Internet 3 via the gateway 13. Moreover, in the local system 2, the terminal 21 and the terminal 22 use the Internet 3 via the gateway 23.

Moreover, the gateway 13 and the gateway 23, or other network devices, or the like are provided with functions such as a firewall, and a proxy server, and a system has been used in which respective terminals use the Internet 3 via these devices, and the safety in the system is improved.

For example, when attempting to access the terminal 11 within the local system 1 from the Internet 3, the global IP address of the gateway 13 can be learned, but the private IP address of the terminal 11 cannot be learned. Therefore, under a general connection method, the terminal 11 cannot be accessed from outside of the local system 1. Moreover, there are cases in which sites which can be accessed are limited by the firewall function or the like of the gateway 13. In addition, the same access limitation applies to the terminal 12, and also applies to the terminal 21 and the terminal 22 within the local system 2.

Furthermore, the terminal 11 and the terminal 12 within the local system 1, and the terminal 21 and the terminal 22 within the local system 2 are generally provided with only client functions, and are not provided with functions as a server for accepting information from other network apparatus. Therefore, unless accessing to other network apparatus with the server function is performed from the terminal 11, the terminal 12, the terminal 21, and the terminal 22, the information cannot be transmitted to these terminals from other network apparatus.

### SUMMARY OF THE INVENTION

A first object of the present invention is to provide a relay server for realizing the communication from the Internet to a network device within a local system, or the communication between network devices within different local systems, and capable of identifying each connection normally, even in the case a plurality of connections exist between each of the network apparatus and the relay server.

A second object of the present invention is to provide a relay server for realizing communication among the network devices within a plurality of local systems via the Internet, and permitting other network apparatus to participate in such communication.

According to one aspect of the present invention, there is provided a relay server including communication means capable of carrying out communication with a plurality of network devices by using at least one connection respectively, and control means for relaying the communication between the network devices by using the communication means. Preferably, the control means manages the connection by a connection identifier that makes it possible to uniquely identify each connection to be used by the communication means for the communication with the network device. With such structure of the relay server and/or the like, by logging to the relay server from the network device, and by relaying the communication for the network device which is in a login state, for example, even in the case the network device is a device within the local system, the communication can be realized from the Internet to the network device. Moreover, since such a connection between the network device and the relay server is managed by the connection identifier, for example, even in the case a plurality of connections are provided between the network devices and the relay server, the communication can be carries out normally for each of the connections.

According to another aspect of the present invention, there is provided a relay server including communication means capable of carrying out communication with a plurality of network devices by using more than one connection respectively and carrying out the communication with another relay server or other relay servers existing on the Internet, and control means for relaying the communication between the network devices or between the network device and another relay server or other relay servers by using the communication means. Preferably, the control means manages the connection by the connection identifier which makes it possible to uniquely identify each connection to be used by the communication means for the communication with the network device, including a connection or connections related to another relay server or other relay severs which can carry out the communication. With such structure of the relay server and/or the like, when a plurality of relay servers exist on the Internet, the communication can be realized between the network devices that are connected to different relay servers. At this time, by assigning, to each connection, the connection identifier that is capable of uniquely identifying each connection in the entire communication system, the normal communication can be ensured even for the connections that are connected to different relay servers.

In the case such a relay system includes a plurality of relay servers existing on the Internet, the connection identifier preferably includes a relay server identifier which makes it possible to identify each relay server as only one relay server (uniquely). A part of such connection identifier (for example, the relay server identifier) may be set in each relay server respectively in advance, or can be obtained from a database server on the Internet. Of course, a relay server may have the same function as that of this database server.

Preferably, at the time the network device makes login, the connection identifier which makes it possible to identify each connection corresponding to this login is sent back to the network device. In this manner, it becomes possible for the network device to accurately identify each connection when the network device uses each connection.

According to another aspect of the present invention, there is provided a relay server including communication means capable of communicating with a plurality of network devices, control means for relaying the communication among a plurality of network devices via the communication means, and storing means for storing the connection information concerning the network device for which the communication is being carried out by the control means. The control means preferably sends back the connection information stored in the storing means as a response to inquiry about the connection information which the control means has received via the communication means from the network. Accordingly, for example, in advance, it is possible to grasp the communication condition of the destination with which the communication will be carried out. In addition to that, in the case in which the relay server stores the information indicating the group comprised of a plurality of network devices for which the relay server relays the communication, it becomes possible to grasp the condition of the group which is carrying out the communication in which participation can be approved. Further, the inquiry can be carried out by specifying the network device, or a search result of the connection information can be obtained by carrying out a search demand.

According to another aspect of the present invention, by receiving indication information which indicates how to deal with the inquiry about the connection condition in advance, it is possible to determine whether or not to send back the connection information when receiving the inquiry about the connection information actually. Accordingly, for example, for the communication that is undesirable to be disclosed, it can be indicated for the replying of the connection information to be not carried out, and for the disclosed communication, it can be indicated to send back the connection information, or it can be indicated to send back the connection information to specific destinations.

According to another aspect of the present invention, in the case of relaying the communication among a plurality of network devices, another network device or other network devices can participate in the group comprised of these network devices, or it is possible to combine groups or divide the group. Moreover, when another network device or other network devices participate, or the groups are combined, the number of the network devices or the like may be limited by providing an upper limit number.

According to another aspect of the present invention, even after the end of the relaying of the communication, the connection information can be held, and in accordance with the demand, based on the connection information being held, the relaying of the communication can be reproduced. In such a case, by specifying the connection information, the reproduction can be demanded.

According to another aspect of the present invention, priority to the communication with the network device can be provided, and thereby, the bandwidth can be ensured when necessary. Accordingly, for example, it is possible to deal with the communication by an application that needs real time characteristics.

Additional objects, aspects, benefits and advantages of the present invention will become apparent to those skilled in the art to which the present invention pertains from the subsequent detailed description and the appended claims, taken in conjunction with the accompanying drawings.

### BREIF DESCRIPTION OF THE DRAWINGS

FIG. 1 is a block diagram showing a first example of a relay system (a communication system) including a first embodiment of a relay server of the present invention;

FIG. 2 is a sequence diagram showing an example of a communication procedure in the first example of the communication system of FIG. 1;

FIG. 3 is a block diagram showing a second example of the relay system (the communication system) including the first embodiment of the relay server of the present invention;

FIG. 4 is a sequence diagram showing an example of a communication procedure in the second example of the communication system;

FIG. 5 is a block diagram showing a third example of the relay system (the communication system) including the first embodiment of the relay server of the present invention;

FIG. 6 is a block diagram showing an example of the communication system including a second embodiment of a relay server of the present invention;

FIGS. 7A and 7B are illustrations showing an example of a procedure for carrying out communication among a plurality of network apparatus in an example of the communication system including the second embodiment of the relay server of the present invention;

FIGS. 8A and 8B are illustrations showing an example of a procedure when participating in a group in an example of the communication system including the second embodiment of the relay server of the present invention;

FIGS. 9A and 9B are illustrations showing an example of a procedure when carrying out combining of groups in an example of the communication system including the second embodiment of the relay server of the present invention;

FIGS. 10A and 10B are illustrations showing an example of a procedure for ending the communication with the group in an example of the communication system including the second embodiment of the relay server of the present invention;

FIGS. 11A and 11B are illustrations showing an example of a procedure when dividing a group in an example of the communication system including the second embodiment of the relay server of the present invention;

FIGS. 12A and 12B are illustrations showing an example of a procedure when reproducing communication in an example of the communication system including the second embodiment of the relay server of the present invention; and

FIG. 13 is a block diagram showing an example of a general system using the Internet.

### DETAILED DESCRIPTION OF THE INVENTION

(First Embodiment)

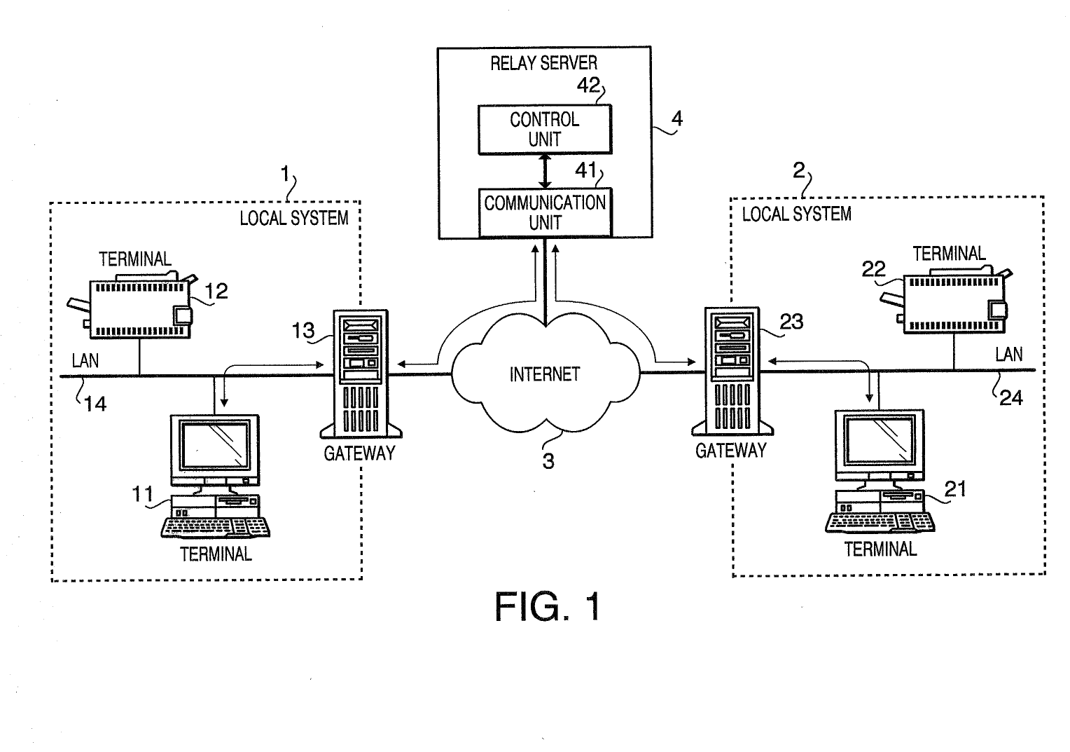

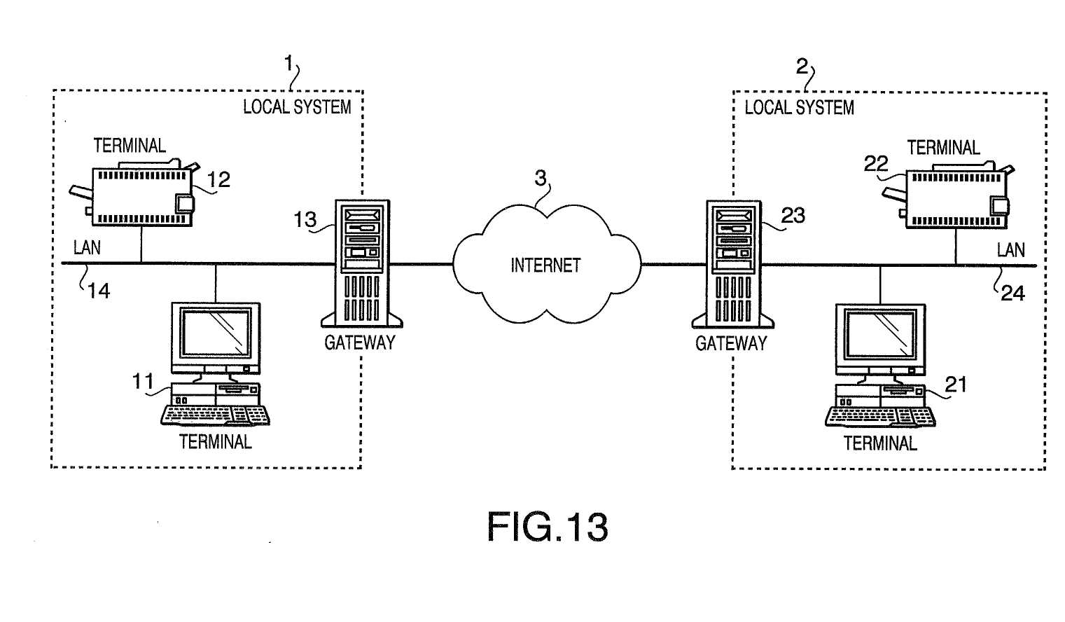

A first embodiment of the present invention will be described with reference to the drawings. In FIG. 1 showing an first example of a relay system, the same reference numerals are attached to the same parts as those of FIG. 13, and overlapping description will be omitted. The reference numeral 4 designates a relay server, 41 a communication unit, and 42 a control unit. The relay server 4 is connected to the Internet 3, and has a global IP address. By using the global IP address, the relay server 4 can carry out the communication with various network apparatus via the Internet 3.

The relay server 4 can be constructed so as to include the communication unit 41, the control unit 42, and the like. The communication unit 41 is capable of carrying out the communication with a plurality of network devices via the Internet 3.

The control unit 42 receives, via the communication unit 41, a login demand transmitted from the network apparatus, and secures a communication path by maintaining the connection with the network apparatus. Moreover, a connection identifier that is capable of identifying a connection uniquely is assigned to the connection with the network apparatus, and the connection identifier is returned to the network apparatus. After each connection identifier is assigned to each connection, the network apparatus and the control unit 42 identify each of the connections by the connection identifier. Furthermore, a plurality of connections can be made with one network apparatus, and the connection identifier is assigned to each of the connections. The connection identifier can be anything if it is able to identify each of the connections. For example, the connection identifier is an assigned serial number, the user ID transmitted at the time login is demanded, the serial number for the connection, the serial number for each user ID, or the like.

Moreover, the control unit 42 receives the login demand, and establishes a new connection as in the manner stated above, and when the communication path is secured, the communication path is maintained until the logout. When the control unit 42 receives the connection demand information from the network device that is connected capable of carrying out the communication, by following the connection demand information, the control unit 42 relays the data forwarding between the network device that is connected capable of carrying out the communication and the network device that demanded the connection.

For example, under the state in which the terminal 11 and the terminal 21 are connected capable of carrying out the communication, and the communication path is secured, when receiving the connection demand information with the terminal 21 from the terminal 11, the control unit 42 carries out forwarding of the data with the terminal 11, and also carries out forwarding of the data with the terminal 21, and the communication is realized between the terminal 11 and the terminal 21 substantially. In this case, the terminal 11 is a network device within the local system 1, and the terminal 21 is a network device within the local system 2. The connection can be made from the relay server 4 to the gateway 13 and the gateway 23, but the connection cannot be made to the terminal 11 or the terminal 21. Moreover, as in the manner stated above, the communication cannot be carried out directly between the terminal 11 and the terminal 21. However, by using the global IP address of the relay server 4, the connection can be made from the terminal 11 to the relay server 4 via the gateway 13, and from the terminal 21 to the relay server 4 via the gateway 23. Therefore, by carrying out the login demand from the terminal 11 or the terminal 21 to the relay server 4, the communication can be carried out in both directions between the relay server 4 and the terminal 11 or the terminal 21 which carried out the login demand.

In the case the communication can be carried out in both directions between the relay server 4 and the terminal 11, and between the relay server 4 and the terminal 21 as in the manner stated above, when the relay server 4 receives the communication demand to the terminal 21 from the terminal 11, the relay server 4 receives the data transmitted from the terminal 11, and transmits the received data to the terminal 21. Accordingly, the data is forwarded from the terminal 11 to the terminal 21. On the other hand, the relay server 4 is also capable of receiving the data transmitted from the terminal 21, and transmitting the received data to the terminal 11. As in the manner stated above, the communication can be realized between the terminal 11 and the terminal 21.

Further, in the case a plurality of connections are secured with one network device, the relay server 4 is capable of relaying the communication with a plurality of network devices. In this case, each of the connections is distinguished by the connection identifier, and the control unit 42 controls the relay communication so that each communication can be carried out normally.

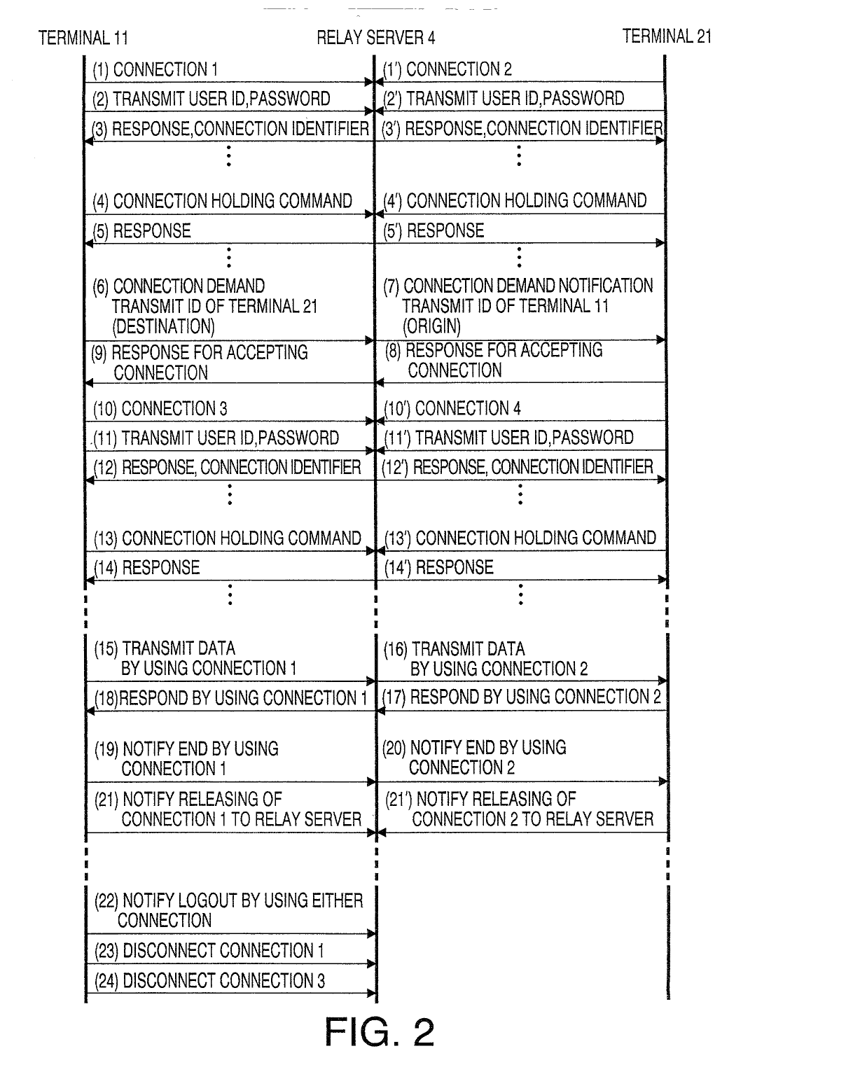

The communication procedure shown in FIG. 2 is carried out by using TCP/IP (Transmission Control Protocol/Internet Protocol), and in this procedure, the connection with the relay server 4, the continuation of the connection, the connection demand to the terminal, the forwarding of the data to the terminal, the end of the connection with the terminal, the end of the connection with the relay server, and so forth are carried out. As one example, FIG. 2 shows a case in which the communication is carried out between the terminal 11 within the local system 1 and the terminal 21 within the local system 2 which are shown in FIG. 1. The terminal 11 and the terminal 21 are registered as users to the relay server 4 in advance. For example, the user ID, the password, or the like is registered to the relay server 4.

For example, after being started or by the instruction of an operator, in (1), the terminal 11 is connected to the relay server 4 via the gateway 13, carries out the login demand, and establishes the TCP/IP connection (connection 1) with the relay server 4. Since the terminal 11 is a network device within the local system 1, the communication cannot be carried out directly from the relay server 4, but by the login from the terminal 11 which is a client, the connection can be made to the relay server 4. Since the TCP/IP connection is capable of carrying out the data communication in both directions, the communication can be carried out from the terminal 11 to the relay server 4, or from the relay server 4 to the terminal 11. Further, the global IP address of the relay server 4 can be obtained from a name service server within each of the local systems or on the Internet.

After the connection 1 is established, in (2), the terminal 11 transmits the user ID and the password to the relay server 4. The relay server 4 examines whether or not the received user ID and the password are held as connection information in the control unit 42, and carries out authentication of the terminal 11. By the authentication, the connection with an unspecified third party can be avoided, and the safety can be maintained. In the case of failing in the authentication in that the connection information is not registered or in that the password is incorrect, the relay server 4 carries out a negative response to the terminal 11, or disconnects the connection 1.

In the case the authentication succeeds, the terminal 11 carries out a positive response to the relay server 4 in (3). At this time, the connection identifier that is capable of identifying the connection 1 uniquely is assigned to the connection 1, and the assigned connection identifier is returned to the terminal 11 along with the positive response. After that, when terminal 11 uses the connection 1, the assigned connection identifier is used.

When the processing of the login is completed as in the manner stated above, the terminal 11 performs control so as to continue the connection 1 until the connection 1 is disconnected. Therefore, the terminal 11 transmits a connection holding command to the relay server 4 periodically in (4), and the response of confirmation of it is obtained from the relay server 4 in (5). In this manner, the connection is held, and the confirmation of whether the relay server 4 is working normally is carried out.

As in the same manner, the terminal 21 makes connection to the relay server 4 via the gateway 23 in (1′), carries out the login demand, and establishes the TCP/IP connection (connection 2) with the relay server 4. Since the terminal 21 is also a network device within the local system 2, the communication cannot be carried out directly from the relay server 4, but the connection can be made to the relay server 4 by the login from the terminal 21 which is a client. By the connection 2, the communication can be carried out from the terminal 21 to the relay server 4, or from the relay server 4 to the terminal 21.

After the connection 2 is established, the terminal 21 transmits the user ID and the password to the relay server 4 in (2′). The relay server 4 examines whether or not the received user ID and the password are held as the connection information in the control unit 42, and carries out the authentication of the terminal 21. In the case of failing in the authentication in that the connection information is not registered or in that the password is incorrect, the relay server 4 carries out the negative response to the terminal 21, or disconnects the connections 2. In the case the authentication succeeds, the relay server 4 carries out the positive response in (3′). At this time, the connection identifier that is capable of identifying the connection 2 uniquely is assigned to the connection 2, and the assigned connection identifier is returned to the terminal 21 along with the positive response. After that, when the terminal 21 uses the connection 2, the assigned connection identifier is used.

When the processing at the time of the login is completed in the manner stated above, until the connection 2 is disconnected, the terminal 21 makes control so as to continue the connection 2. Therefore, the terminal 21 transmits the connection holding command to the relay server 4 periodically in (4′), and obtains the response of the confirmation of it from the relay server 4 in (5′). Accordingly, the connection is held, and the confirmation of whether the relay server is working normally is carried out.

Further, the connection between the terminal 11 and the relay server 4, and the connection between the terminal 21 and the relay server 4 can be carried out at any time so long as it is before both communication is carried out. Moreover, it is necessary for the connection between the terminal 11 and the relay server 4, and the connection between the terminal 21 and the relay server 4 to be continued until both communication is carried out.

When a demand is generated that the connection is to be made from the terminal 11 to the terminal 21, the terminal 11 designates the user ID of the terminal 21 to which the terminal 11 intends to make the connection, and the terminal 11 carries out the connection demand to the relay server 4 in (6). Further, the user ID of the terminal 21 which is to be the connection destination can be obtained in advance or designated by any methods. For example, the user ID of the terminal 21 is designated by making confirmation of a list or the like of users which are in the login state. This list can be obtained from the relay server 4. When the terminal 21 corresponding to the designated user ID is not in the login state (the state in which the vacant connection is present), the relay server 4 returns an error message to the terminal 11. Moreover, when the terminal 21 is in the login state, in (7), the relay server 4 transmits the connection demand notification including the information that there is the connection demand to the terminal 21 and including the user ID of the terminal 11 which is demanding the connection, through any connection that is vacant. In this example, the connection demand notification is transmitted to the terminal 21 through the connection 2.

The terminal 21 stores that the connection used in the transmission of the connection demand notification is used in the connection with the terminal 11, and in (8), the terminal 21 returns the response for accepting the connection. Further, when rejecting the connection, the terminal 21 returns an error message. The relay server 4 sends back the response from the terminal 21 to the terminal 11 in (9). In the case the response from the terminal 21 is a response for accepting the connection, the relay server 4 stores that the connection 1 is to be used in the communication with the terminal 11, and the connection 2 is to be used in the communication with the terminal 21. Moreover, in the case of receiving the response for accepting the connection, the terminal 11 which received the response from the terminal 21 stores that the connection in use (connection 1) is to be used for the communication with the terminal 21.

After confirming that the communication is to be carried out between the terminal 11 and the terminal 21 as in the manner stated above, the data is transmitted actually after (15). Further, in the example shown in FIG. 2, after it is determined that the communication is to be carried out between the terminal 11 and the terminal 21, both the terminal 11 and the terminal 21 establish new TCP/IP connections with the relay server 4 respectively in order to accept the connection demand from the other network apparatus, or carry out the connection demand to other network apparatus. In other words, the terminal 11 makes the login to the relay server 4, and establishes the TCP/IP connection (connection 3) with the relay server 4 in (10), and the terminal 11 transmits the user ID and the password to the relay server 4 in (11). The relay server 4 carries out the authentication of the terminal 11 by the received user ID and password, and in (12), returns the response. At this time, the connection identifier which differs from those of any other connections including the connection 1 and the connection 2 is assigned to the connection 3, and the assigned connection identifier is returned to the terminal 11 along with the response of (12) through the connection 3. After that, the terminal 11 transmits the connection holding command to the relay server 4 periodically in (13) to maintain the connection 3, and the relay server 4 returns the response to the terminal 11 in (14).

As in the same manner, the terminal 21 makes the login to the relay server 4, and establishes the TCP/IP connection (connection 4) with the relay server 4 in (10′). Subsequently, the terminal 21 transmits the user ID and the password to the relay server 4 in (11′). The relay server 4 carries out the authentication of the terminal 21 by the received user ID and the password, and returns the response in (12′). At this time, the connection identifier which differs from those of any other connections including the connections 1, 2, and 3 is assigned to the connection 4, and the assigned connection identifier is returned to the terminal 21 along with the response of (12′) through the connection 4. After that, the terminal 21 transmits the connection holding command to the relay server 4 periodically in (13′) to maintain the connection 4, and the relay server 4 returns the response to the terminal 21 in (14′).

Further, in the case it is not necessary to secure such a vacant connection, the processes of (10) to (14) or (10′) to (14′) are not necessary. Furthermore, in the case a plurality of connections have been already secured, these processes are not required to be carried out. Moreover, also in the case the upper limit number of connections is set, and any further connection cannot be carried out, such processes are not carried out.

When confirming that the communication is to be carried out between the terminal 11 and the terminal 21 in (6) to (9), the terminal 11 transmits the data for the terminal 21 to the relay server 4 through the connection 1 in (15). The relay server 4 receives the data from the terminal 11, and transmits the received data to the terminal 21 through the connection 2 in (16). The terminal 21 receives the data from the terminal 11 transmitted from the relay server 4 through the connection 2, and in (17), terminal 21 transmits the response for the terminal 11 to the relay server 4. The relay server 4 receives the response to the terminal 11 from the terminal 21, and in (18), the relay server 4 transmits the received response to the terminal 11 through the connection 1.

As in the manner stated above, by using the connection 1 between the terminal 11 and the relay server 4, and the connection 2 between the terminal 21 and the relay server 4, and by relaying the data by the relay server 4, the communication can be carried out between the terminal 11 and the terminal 21. Further, the data forwarding from the terminal 11 to the terminal 21 in (15) to (18) can be repeated several times. Moreover, the data forwarding can be carried out from the terminal 21 to the terminal 11.

When the data forwarding is completed between the terminal 11 and the terminal 21, end notification is carried out from the terminal 11 or the terminal 21. In this example, it is assumed that the end notification is carried out from the terminal 11, and the terminal 11 transmits the end notification for the terminal 21 to the relay server 4 through the connection 1 in (19). The relay server 4 transmits the end notification for the terminal 21 which has been received from the terminal 11, to the terminal 21 through the connection 2 in (20). The terminal 11 which transmitted the end notification also transmits releasing notification to the relay server 4 in (21). This releasing notification indicates that the connection 1 has become vacant. Moreover, the terminal 21 which received the end notification also transmits the releasing notification to the relay server 4 in (21′), indicating that the connection 2 has become vacant. Accordingly, the relay server 4 stores that the connection 1 and the connection 2 are not used for the communication between the terminal 11 and the terminal 21, and that the connections have become vacant. Further, in this example, the response to the end notification is not carried out, but the response may be sent back.

By performing the connection holding command and the response of it periodically as shown in (4), (5), or (4′), (5), the connection 1 and the connection 2 which were released in such a manner are maintained between the terminal 11 and the relay server 4, and between the terminal 21 and the relay server 4

At this time, the connection 1 and the connection 3 are secured between the terminal 11 and the relay server 4. In addition to that, the connection 2 and the connection 4 are also secured between the terminal 21 and the relay server 4. These connections may be maintained as it is, or when the connection 1 and the connection 2 are released, these connections may be disconnected. Alternatively, the connection 1 and the connection 2 may be continued, and the connection 3 and the connection 4 may be disconnected.

In the case the terminal 11 cuts power supply from a power source, or in the case the connection to the relay server 4 is ceased, in (22), the terminal 11 notifies the logout to the relay server 4. At this time, in the case a plurality of connections are secured, the notification of the logout can be carried out through any connection. Subsequently, the terminal 11 disconnects all connections, and ends the communication. In this example, the connection 1 is disconnected in (23), the connection 3 is disconnected in (24), and then the communication is ended. The relay server 4 receives the notification of the logout from the terminal 11, recognizes the logout of the terminal 11, and disconnects all connections (connection 1, connection 3) with the terminal 11. The same processes can apply to the case in which the terminal 21 performs the logout.

By carrying out the above-mentioned procedure, even in the case both of or one of the terminals is a network apparatus within the local system or the local systems, the communication can be carried out. Further, it is possible to make the procedure for carrying out the connection with the relay server 4, continuing the connection, demanding the connection to the terminal, transmitting the data to the terminal, ending the connection with the terminal, and ending the connection with the relay server so as to maintain permeability to and give no influence on the command or the data exchanged by the application protocol working in an upper level, and it is possible to carry out the communication by using the existing application protocol as it is.

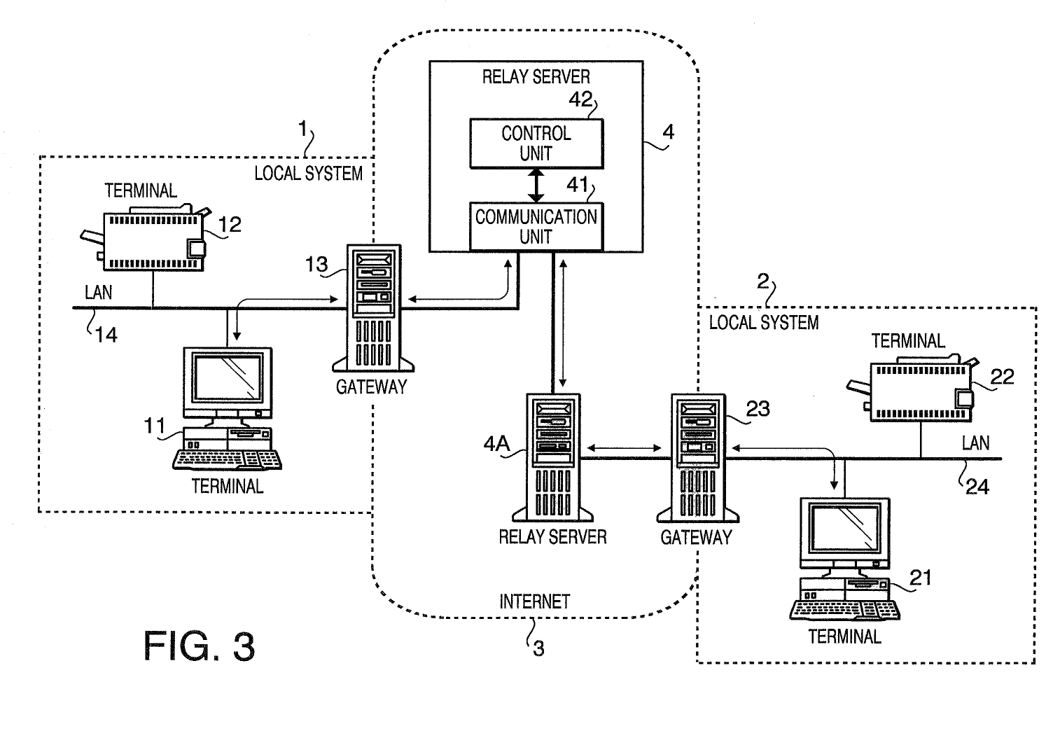

A second example of the relay system including the relay server of the first embodiment of the present invention will be described. In FIG. 3, the same reference numerals are attached to the same parts as those of FIG. 1, and the overlapping description will be omitted. The reference numeral 4A designates a relay server. In the second example of the relay system, a plurality of relay servers exist on the Internet 3. In this example of FIG. 3, only two relay servers 4 and 4A are shown, but more relay servers can exist.

The relay server 4 and a relay server 4A have the same structure, and each of the relay servers can be connected to one or a plurality of the network devices to carry out the communication. Furthermore, the relay server 4 and the relay server 4A perform the communication with each other so that the communication can be carried out between the network device which has made the login to the relay server 4 and the network device which has made the login to the relay server 4A.

For example, the terminal 11 secures a connection to the relay server 4 via the gateway device 13, and the terminal 21 secure a connection to the relay server 4A via the gateway device 23. After that, when the connection demand is carried out from the terminal 11 to the terminal 21, the relay server 4 relays the connection demand to the relay server 4A, the relay server 4A relays the connection demand to the terminal 21, and in this manner, the connection demand from the terminal 11 arrives at the terminal 21. By using the same path, the information can be forwarded from the terminal 11 to the terminal 21. Moreover, by using the path of an opposite direction, the information can be forwarded from the terminal 21 to the terminal 11.

In such a relay system in which a plurality of relay servers exist on the Internet 3, it is necessary that the connection provided by making the login to each of the relay servers should be identified uniquely or as one connection in the entire relay system. In other words, it is necessary that each connection with one relay server should be identified uniquely or as one connection, and be also distinguished from any connections with other relay servers. Therefore, it is required that the same connection identifier to be assigned to a connection should not be used again within the relay system.

As one method, it can be proposed that the relay servers assign serial numbers as connection identifiers in cooperation with each other such that the serial numbers do not overlap each other. In this case, it is necessary to eliminate the overlapping of the connection identifiers when the login demands are made to different relay servers almost simultaneously. For this reason, for example, an identifier server can be provided for assigning the connection identifier such that the assignment of the connection identifier must be received from the identifier server without a fail. Alternatively, a range of the assignable connection identifier can be determined to each relay server in advance, and each relay server can assign connection identifiers to respective connections by using determined range of connection identifiers. That is, each relay server can use connection identifiers within the determined range.

In addition to that, for assigning the connection identifier more easily, relay server identifiers which do not overlap each other within the relay system can be assigned to respective relay servers. A connection identifier including the relay server identifier is assigned to each of the connections. By creating connection identifiers as in such a manner, even when respective relay servers create connection identifiers independently of each other, the connection identifiers which do not overlap each other within the relay system can be created and assigned.

Furthermore, by using the user ID, different identifiers can be used to respective network devices related to respective relay servers. In other words, when using the relay server identifier and the user ID, “user ID+relay server identifier+connection number” can be used as the connection identifier. It is generally ensured that the user IDs do not overlap each other overlap within the relay system. In addition to that, as in the manner stated above, it is ensured that the relay server identifiers also do not overlap each other within the relay system. Therefore, by using connection numbers which are assigned to respective connections of each network device and are guaranteed to overlap each other, it is possible to ensure that the connection identifiers do not overlap each other within the relay system, and identify each connection uniquely or as one connection within the relay system.

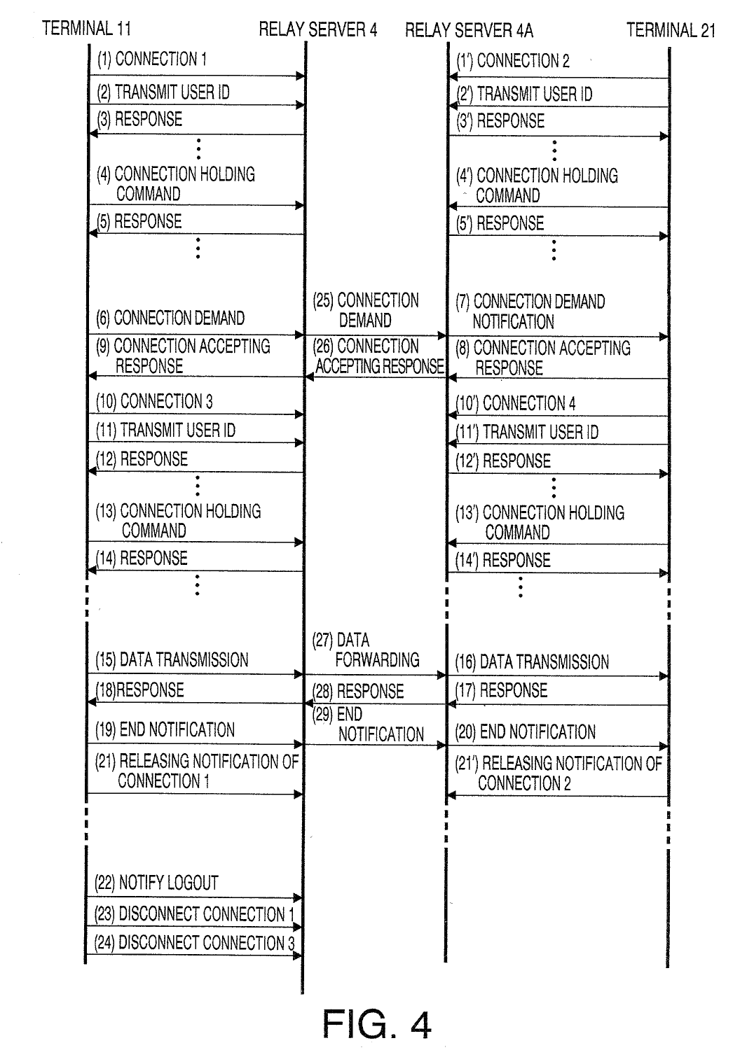

A procedure in the second example of the relay system including the relay server of the first embodiment of the present invention will be described with reference to FIG. 4. In FIG. 4, the same process numbers are attached to the same processes of FIG. 2. In this example, the connection is made between the terminal 11 of the local system 1 and the relay server 4, the connection is made between the terminal 21 of the local system 2 and the relay server 4, and the communication is carried out between the terminal 11 and the terminal 21.

The terminal 11 makes the login to the relay server 4 in (1) to (3). The relay server 4 returns the connection identifier of the connection 1 to the terminal 11 at the time the response is made in (3). For example, the connection identifier can be created based on the user ID transmitted from the terminal 11, the relay server identifier of the relay server 4, and the connection number assigned to the connection 1. After that, when the terminal 11 carries out the communication by using the connection 1, the connection identifier corresponding to the connection 1 is used. The connection 1 is then held by the connection holding command in (4) and the response of it in (5).

As in the same manner, the terminal 21 makes the login to the relay server 4A in (1′) to (3′). The relay server 4A returns the connection identifier of the connection 2 to the terminal 21 at the time the response is made in (3′). For example, at this time, the connection identifier can also be created based on the user ID transmitted from the terminal 21, the relay server identifier of the relay server 4A, and the connection number assigned to the connection 2. The created connection identifier does not overlap any other connection identifiers in the entire relay system. After that, when the terminal 21 carries out the communication by using the connection 2, the connection identifier corresponding to the connection 2 is used. The connection 2 is then held by the connection holding command in (4′) and the response of it in (5′).

When carrying out the communication from the terminal 11 to the terminal 21, the terminal 11 carries out the connection demand to the relay server 4 in (6). The relay server 4 detects that the terminal 21 of the destination is connected to the relay server 4A, and in (25), the relay server 4 forwards the connection demand received from the terminal 11 to the relay server 4A. Various methods can be used in order to determine which relay server the destination is connected to. For example, the information concerning the connection is exchanged between the relay servers in advance, or each relay server is asked at the time necessity is generated, or the database server is asked which carries out the management of the users that are connected to the respective relay servers.

The relay server 4A forwards the connection demand forwarded from the relay server 4 to the terminal 21 in (7). The response to the connection demand is forwarded to the terminal 11 through the same path in an opposite direction. In other words, the response is forwarded from the terminal 21 to the terminal 11 via the relay server 4A and the relay server 4. The data is forwarded from the terminal 11 to the terminal 21 in (15), (27), and (16) through the same path, and the response can be returned in (17), (28), (18).

In the same manner as the case of the connections 1 and 2, the connection 3 is secured in (10) to (12) and maintained in (13) and (14), and the connection 4 is also maintained in (10′) to (12′) and maintained in (13′) and (14′). Furthermore, the processes at the time of the logout are performed in the same manner as processes shown in FIG. 2.

As in the manner stated above, the communication can be carried out between the network devices that are connected to different relay servers. Further, still more relay servers can be provided on the Internet 3, the relay server for relaying the communication between the relay servers can be provided, and thereby the communication between the network devices can be realized by relaying through a plurality of relay servers. Of course, the communication between the network devices that are connected to the same relay server can be carried out in the same manner as the above-mentioned first example.

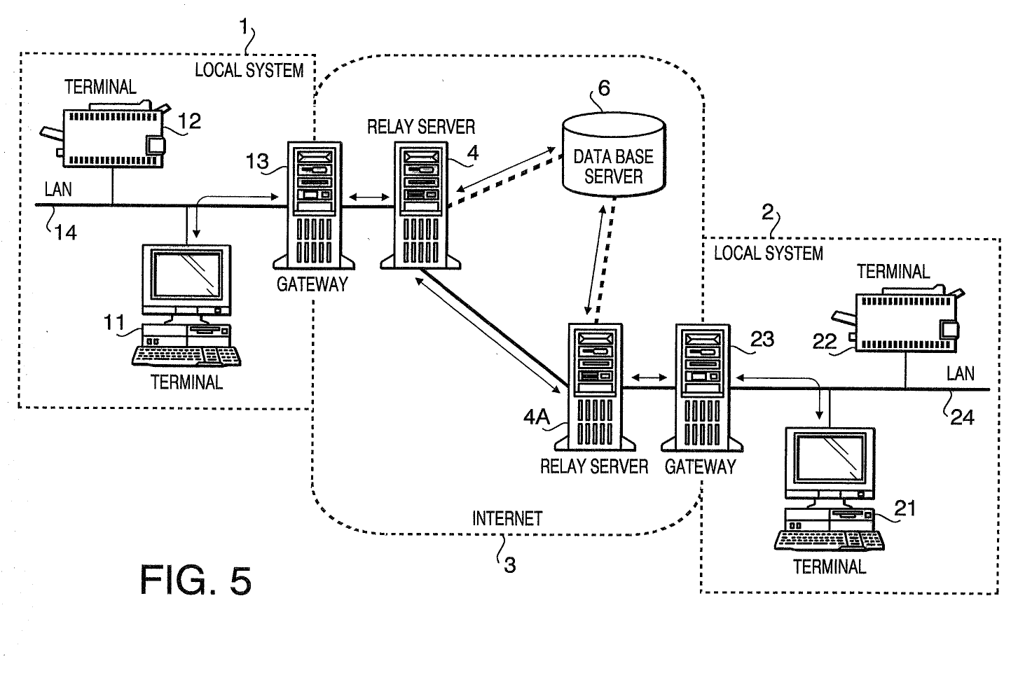

A third example of the relay system including the relay server of the first embodiment of the present invention will be described. In FIG. 5, the same reference numerals are attached to the same parts of FIG. 2, and the overlapping description will be omitted. The reference numeral 6 designates a database server. In the second example, the respective relay server identifiers which can be identified uniquely or as one connection are attached to the respective relay servers on the Internet 3 in advance. However, in the case a new relay server is added to the relay system, a relay server identifier which is different from any other identifiers is required to be attached to the new relay server. Accordingly, there is possibility that management cost for dealing with the new relay server identifier is increased.

In the third example shown in FIG. 5, the database server 6 for managing the relay server identifiers is provided to reduce such a problem. The database server 6 manages the relay server identifiers assigned to the relay server within the relay system. Moreover, when a new relay server is added to the relay system, the database server 6 assigns a new relay server identifier which does not overlap any other relay server identifiers. The relay server added to the relay system accesses the database server 6 to obtain the relay server identifier. After that, the relay server starts the relay processing.

By forming the relay system in the manner stated above, the burden on the management of the relay server identifier by human hands can be reduced, and the assignment of the relay server identifiers which do not overlap each other within the relay system can be carried out. Furthermore, since it is ensured that the respective relay server identifiers overlap each other, and the respective relay servers create connection identifiers which do not overlap each other within the respective relay servers by using the respective relay server identifiers as one part of connection identifiers, it is possible to assign, to the respective connections, the connection identifiers which do not overlap each other within the entire relay system.

Further, the database server 6 can be provided apart from the relay servers as shown in FIG. 5, or any one of the relay servers within the relay system can carry out the same function as that of the database server.

(Second Embodiment)

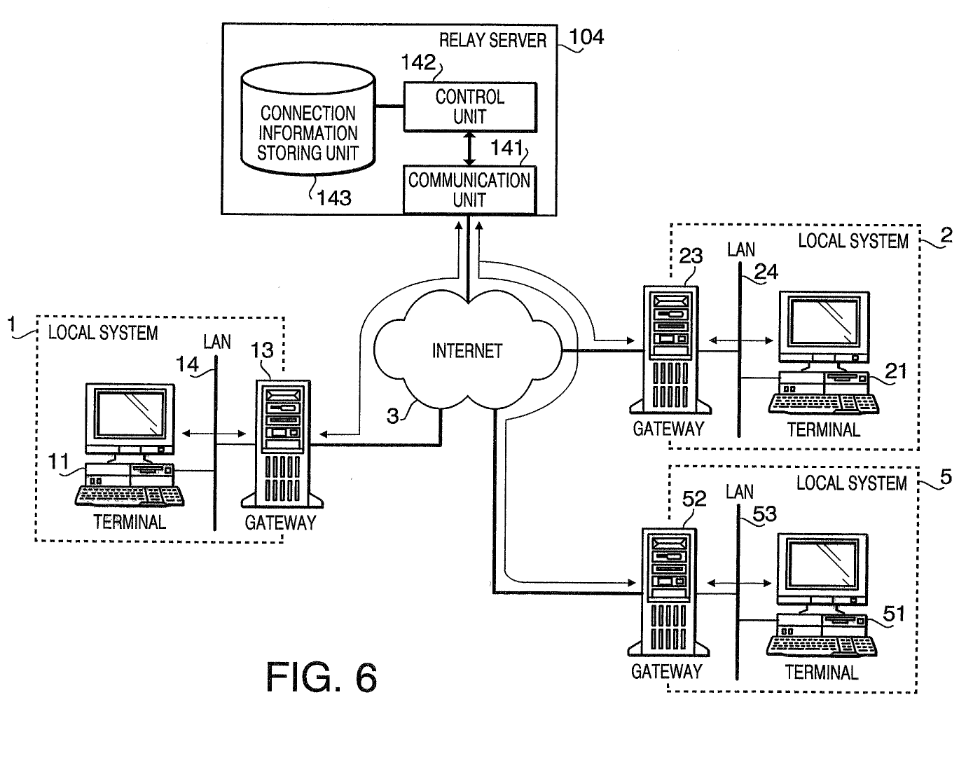

According to a second embodiment of the present invention, communication system as well as a relay server will be described with reference to the drawings. In FIG. 6, the same reference numbers are attached to the same parts as those of FIG. 13, and the overlapping description will be omitted. The reference numeral 104 designates a relay server, 141 a communication unit, 142 a control unit, 143 a connection information storing unit, 5 a local system, 51 a terminal, 52 a gateway, and 53 a LAN. Only one terminal is shown in each local system, but a plurality of terminals can be provided.

The local system 5 is the same system as the local system 1 and the local system 2, and the terminal 51, the gateway 52 and the like are connected by the LAN 53 to form the local system 5. The gateway 52 is connected to the Internet 3 along with the LAN 53, and the Internet can be used from various network apparatus such as the terminal 51 on the LAN 53.

The relay server 104 is connected to the Internet 3, and has the global IP address. The relay server 104 can carry out the communication with various network apparatus via the Internet 3 by using the global IP address. The relay server 104 can be provided with the communication unit 141, the control unit 142, the connection information storing unit 143, and the like. The communication unit 141 is capable of carrying out the communication with a plurality of network apparatus via the Internet 3.

The control unit 142 receives the login demand transmitted from the network apparatus via the communication unit 141, and secures the communication path by maintaining the connection with the network apparatus. Moreover, when the control unit 142 receives the login demand, and the communication path is secured as in the manner stated above, the communication path is maintained until the logout. In addition, a plurality of connections can be made with one network apparatus. When receiving the connection demand information from the network apparatus that is connected capable of carrying out the communication, by following the connection demand information, the control unit 142 relays the data forwarding between the network apparatus that demanded the connection and the network apparatus which received the demand for the connection and connected to the relay server 104 such that the communication can be carried out, or between the network apparatus which demanded the connection and the group formed by a plurality of network apparatus which is connected to the relay server 104 such that the communication can be carried out. Accordingly, the communication is realized between the network apparatus. For example, it is possible to realize the communication between one network apparatus and a plurality of network apparatus, or between a plurality of network apparatus and a plurality of network apparatus. In other words, one-to-plural or plural-to-plural communication can be realized. Of course, it is possible to carry out the communication between one network apparatus and one network apparatus. In other words, one-to-one communication can be realized.

In the case the relay server is relaying the data forwarding with each network apparatus, the connection information storing unit 143 stores the connection information of the network apparatus between which the relaying of the communication is being carried out. For example, when the one-to-one communication is being carried, the information for specifying the network apparatus of both sides can be stored as the connection information. Alternatively, the information concerning the group formed by a plurality of network apparatus can be stored as the connection information. Such connection information can be disclosed to a part of or all of the other network apparatus in accordance with the setting from the network apparatus that is carrying out the communication. The setting can be carried out, for example, by determining it in advance, or indicating it at the time or after the network apparatus makes the login to the relay server 104.

Moreover, the control unit 142 receives a reference demand or a search demand concerning the connection information from other network apparatus which are in connection with the relay server 104, and searches for the connection information stored in the connection information storing unit 143. If the setting has been made such that the connection information resulting from the searching can be disclosed, the relay server 104 sends back this connection information to the network device which demanded the connection information. At the network apparatus which demanded the connection information, based on the connection information received from the relay server 104, by designating the desired network apparatus or the group and transmitting the connection demand to the relay server 104, the communication can be carried out with the designated network apparatus or the group. In addition, following a demand from the network apparatus that is carrying out the communication, for example, the communication can be ended, or the group or groups can be divided or combined.

Furthermore, following the demand from the network apparatus, the control unit 142 takes out the connection information of the communication which was carried out in the past from the connection information storing unit 143, and can relay the communication between the network apparatus which are in the login state based on this connection information. Accordingly, for example, the communication can be started easily in the group of a plurality of network apparatus that carries out the communication frequently.

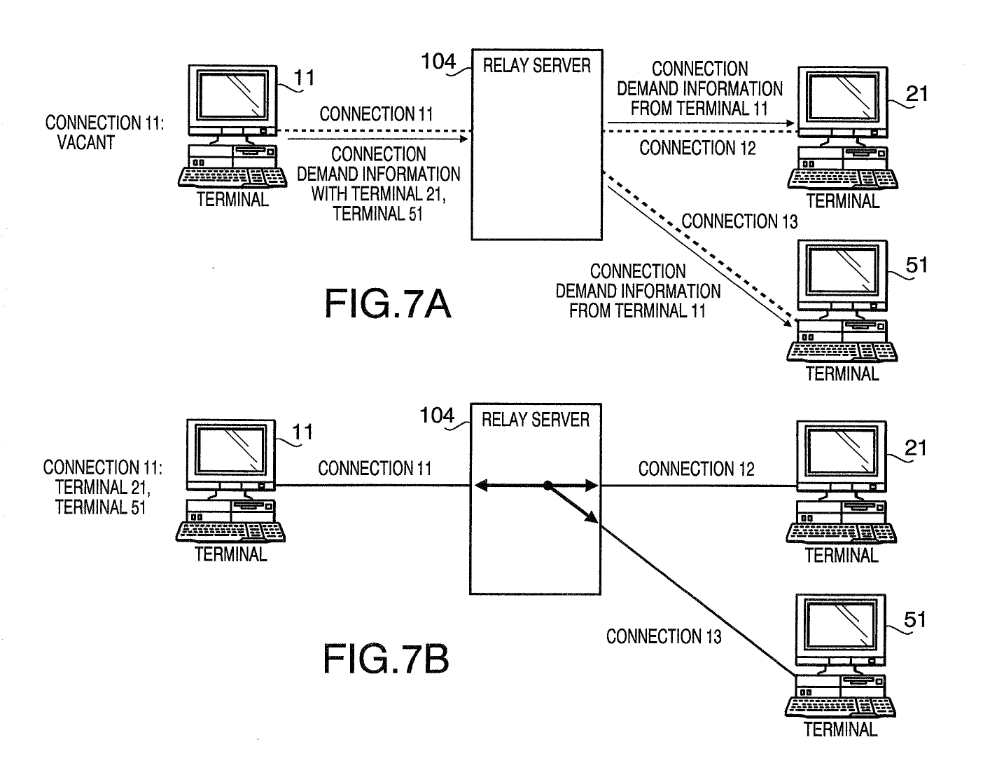

A procedure in one example of the relay system including the relay server of the second embodiment of the present invention will be described with reference to FIGS. 7A and 7B. Further, in each of the drawings, the gateway and the like are omitted, and the only TCP/IP connection between each terminal (network apparatus) and the relay server 104 is shown. As for lines showing each connection in the drawings, a broken line shows the condition in which the connection is not used for the communication with other network apparatus by the protocol of application layer (application level), and a solid line shows the condition in which the connection is used for the communication with other network apparatus. The same lines are applied to the drawings to be used for the description of the procedure.

In FIG. 7A, the terminal 11 is connected capable of carrying out the communication with the relay server 104 by the connection 11. Moreover, as in the same manner, the terminal 21 is connected capable of carrying out the communication with the relay server 104 by the connection 12, and the terminal 51 is connected capable of carrying out the communication with the relay server 104 by the connection 13. Further, at this point, it is assumed that each connection is not to be used for the communication with other network apparatus.

The reservation (securing) of the connection with the relay server 104 can be carried out by demanding the login to the relay server 104 via the Internet 3. The connection is established with the relay server 104 at the time of the login, and then, the communication can be carried out with the relay server 104 by using the established connection. The terminal 11 is a network apparatus within the local system 1, the terminal 21 is a network apparatus within the local system 2, and the terminal 51 is a network apparatus within the local system 5. The connection can be made from the relay server 104 to the gateway 13, the gateway 23, and the gateway 52, but the connection cannot be made directly to the terminal 11, the terminal 21, and the terminal 51. Moreover, as in the manner stated above, the direct communication cannot be carried out reciprocally between the terminal 11, the terminal 21, and the terminal 51. However, by using the global IP address of the relay server 104, the connection can be made from the terminal 11, the terminal 21, and the terminal 51 to the relay server 104 via the gateway 13, the gateway 23, and the gateway 52. Therefore, by carrying out the login demand from the terminal 11, the terminal 21, and the terminal 51 to the relay server 104, the communication can be carried out in both directions between the relay server 104 and the terminal 11, the terminal 21, or the terminal 51 which carried out the login demand.

Moreover, at the time of the login, for example, the information which is necessary at the time of the login, such as the user ID, the password or the like, is transmitted from the network apparatus to the relay server 104. The relay server 104 carries out the authentication based on the received user ID and the password or the like. By this authentication, the connection with an unspecified third party can be avoided, and the safety can be secured. In the case of failing in the authentication in that the connection information is not registered or in that the password is incorrect, the relay server 104 carries out the negative response to the terminal 11, or disconnects the connection 11. In the case the authentication succeeds, the positive response is carried out to the network apparatus that made the login, and then, until the connection is disconnected, the connection is controlled to be continued. In other words, the connection can be continued by transmitting the connection holding command to the relay server 104 periodically, and obtaining the response of the confirmation from the relay server 104.

Furthermore, various setting information can be transmitted to the relay server 104 at the time of the login. For example, when the network apparatus that made the login is carrying out the communication with other network apparatus, the setting can be made to disclose or to notify the connection information to a part of or all of the other network apparatus, or not to disclose or notify it. Moreover, such setting can be changed actively even after the login.

By the above-mentioned login demand, for example, under the state in which the terminal 11, the terminal 21, and the terminal 51 are connected to the relay server 104 respectively in the manner the communication can be carried out, and in which the communication paths are secured, as an example, the connection demand information for the terminal 21 and the terminal 51 is transmitted from the terminal 11 to the relay server 104. When the relay server 104 receives the connection demand information from the terminal 11, the destination indicated in the connection demand information is recognized as the terminal 21 and the terminal 51, and the connection demand information from the terminal 11 is forwarded through the connection 12 secured between the terminal 21 and the relay server 104, and the connection 13 secured between the terminal 51 and the relay server 104. In the case the response returned from the terminal 21 is the positive response, the relay server 104 stores the connection 12 secured for the terminal 21 as the connection to be used for the communication with the terminal 11. In the case the response returned from the terminal 51 is the positive response, the relay server 104 stores the connection 13 secured for the terminal 51 as the connection to be used for the communication with the terminal 11. Then, the relay server 104 sends back the response returned from each of the terminal 21 and the terminal 51 to the terminal 11.

When the terminal 21 and the terminal 51 carry out the positive response to the connection demand from the terminal 11, as shown in FIG. 7B, the communication can be carried out from the terminal 11 to the terminal 21 and the terminal 51. In other words, the relay server 104 receives the information transmitted from the terminal 11 through the connection 11, and forwards the received information to the terminal 21 through the connection 12, and forwards it to the terminal 51 through the connection 13. Accordingly, the information transmitted from the terminal 11 through one connection is to reach a plurality of terminals (the terminal 21 and the terminal 51). Moreover, in the case the positive response is returned from only a part of the network apparatus, the only network apparatus that carried out the positive response becomes the target to which the communication is relayed.

On the other hand, since by each connection, the communication can be carried out in both directions, the relay server 104 can receive the data transmitted from the terminal 21, and transmit the received data to the terminal 11, or the relay server 104 can receive the data transmitted from the terminal 51, and transmit the received data to the terminal 11. As in the manner stated above, by using one connection between the terminal 11 and the relay server 104, the one-to-plural communication can be realized with a plurality of network apparatus, such as the terminal 21, the terminal 51 and the like. Furthermore, the data transmitted from the terminal 21 can be transmitted to the terminal 11 and the terminal 51, and the data transmitted from the terminal 51 can be received by the relay server 104, and the received data can be transmitted to the terminal 11 and the terminal 21.

When the communication is being carried out among a plurality of network apparatus as in the manner stated above, regarding the group composed of the network apparatus that are carrying out the communication, the information designating the group, such as the group name or the keyword, can be registered as the connection information. The registration can be carried out in accordance with the demand from the network apparatus that is a member of the group. Alternatively, in advance, the information for designating the group may be set so as to correspond to the network apparatus of the member. The setting can be made regarding whether or not to disclose the information designating the group to the other network apparatus, or to disclose it to only a part of the network apparatus.

Such connection information can be searched for from other network apparatus. For example, in the case the name of the group, the keyword, or the like is registered as the connection information, the search for the keyword can be requested to the relay server 104 from other network apparatus. At the relay server 104, when receiving the search demand, the control unit 142 searches for the connection information stored in the connection information storing unit 143. Subsequently, among the connection information resulting from the search, the relay server 104 replies to the network apparatus of the origin that the only connection information is disclosed to the origin which demanded the searching of the connection information. Of course, apart from the keyword searching, by specifying the ID of the network apparatus or the like, the disclosure of the connection information of this network apparatus can be requested. In addition, it is possible to demand all the information that is disclosed to the network apparatus of the origin, among the connection information of the network apparatus or/and the group(s) that are carrying out the communication.

By such searching of the connection information, for example, the user that is using the network apparatus of the origin can learn whether or not the destination with which the network apparatus of the origin demanding the connection information intends to carry out the communication is in the communication state, or which group is a group in which the network apparatus of the origin intends to participate. By such searching, the network apparatus of the origin can participate in the group that is carrying out the communication in the manner to be described as follows.

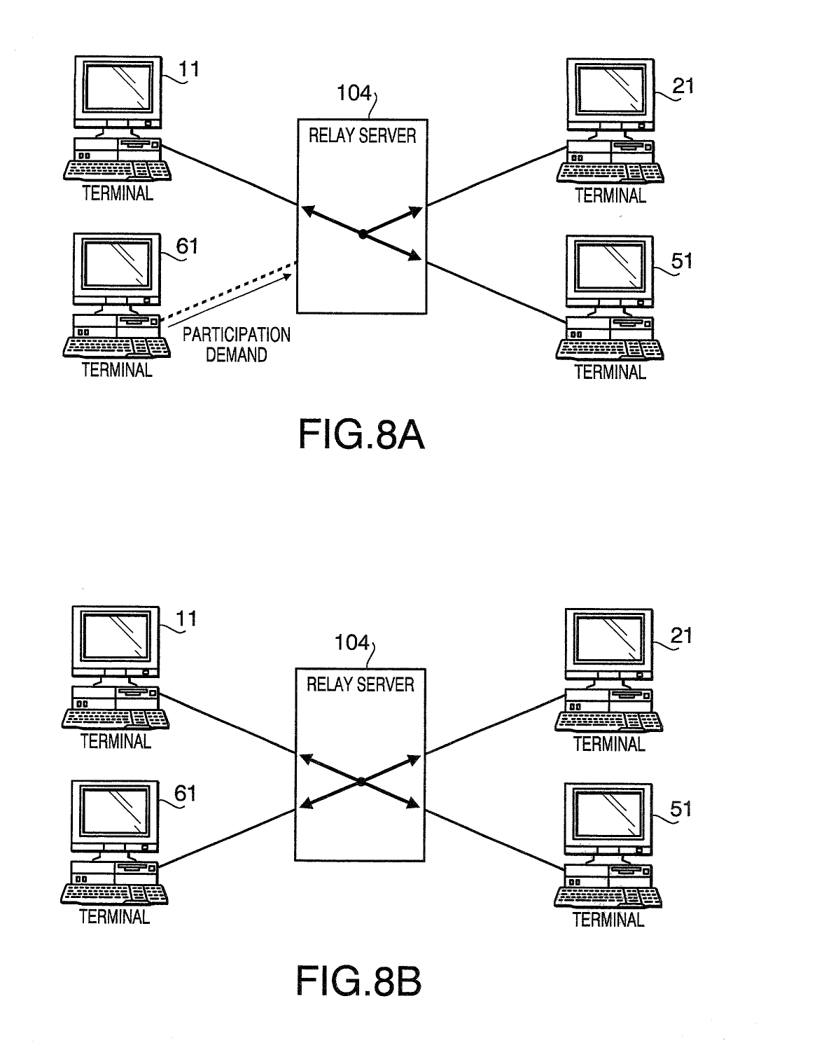

A procedure for participating in a group in one example of the communication system including the second embodiment of the relay server of the present invention will be described with reference to FIGS. 8A and 8B. In FIGS. 8A and 8B, the reference number 61 designates a terminal. In the example shown in FIGS. 8A and 8B, the terminal 61 newly participates under the state in which the communication is being carried out among three parties, i.e., the terminal 11, the terminal 21, and the terminal 51. Further, the terminal 61 is a network apparatus similar to the terminal 11, the terminal 21, the terminal 51, or the like. It is assumed that the terminal 61 makes the login to the relay server 104 in advance, and thereby, the connection is secured with the relay server 104.

In FIG. 8A, the terminal 11, the terminal 21, and the terminal 51 carry out the data forwarding with the relay server 104, and by relaying the data forwarding by the relay server 104, the communication is realized among the terminal 11, the terminal 21, and the terminal 51. At this time, the terminal 11, the terminal 21, and the terminal 51 form the group, and the information for specifying the group is stored as the connection information in the connection information storing unit 143 within the relay server 104. Further, it is to be assumed that the connection information of the group formed by the terminal 11, the terminal 21, and the terminal 51 is set such that the connection information can be disclosed to at least the terminal 61.

Under this state, by demanding the searching of the connection information to the relay server 104 as in the manner stated above, the terminal 61 can obtain various connection information including the connection information of the group formed by the terminal 11, the terminal 21, and the terminal 51. When the terminal 61 joins the group that is formed by the terminal 11, the terminal 21, and the terminal 51, the terminal 61 carries out a connection demand to the relay server 104 by using the connection information of the group formed by the terminals 11, 21, and 51 out of the obtained connection information. When the connection demand is approved, as shown in FIG. 8B, the terminal 61 joins the group, and the communication can be carried out among the respective terminals in the group that is formed by the terminal 11, the terminal 21, the terminal 51, and the terminal 61.

The setting of the approval of the connection demand may be made in advance, for example, such that other network apparatus can or cannot join the group, such that only transmission from other network apparatus can be approved, or such that only receiving from other network apparatus can be approved. Alternatively, the approval of the connection demand may be carried out by asking each network apparatus in the group or a representative of the network apparatus about whether or not the participation in the group is approved, and the result of the asking may be followed.

Moreover, an upper limit can be provided for the number of the network apparatus that can participate in the group, and thereby, the number of the network apparatus which can participate can be limited. In this case, the relay server 104 may reject further participation in the group in which the upper limit number of the network apparatus have already participated.

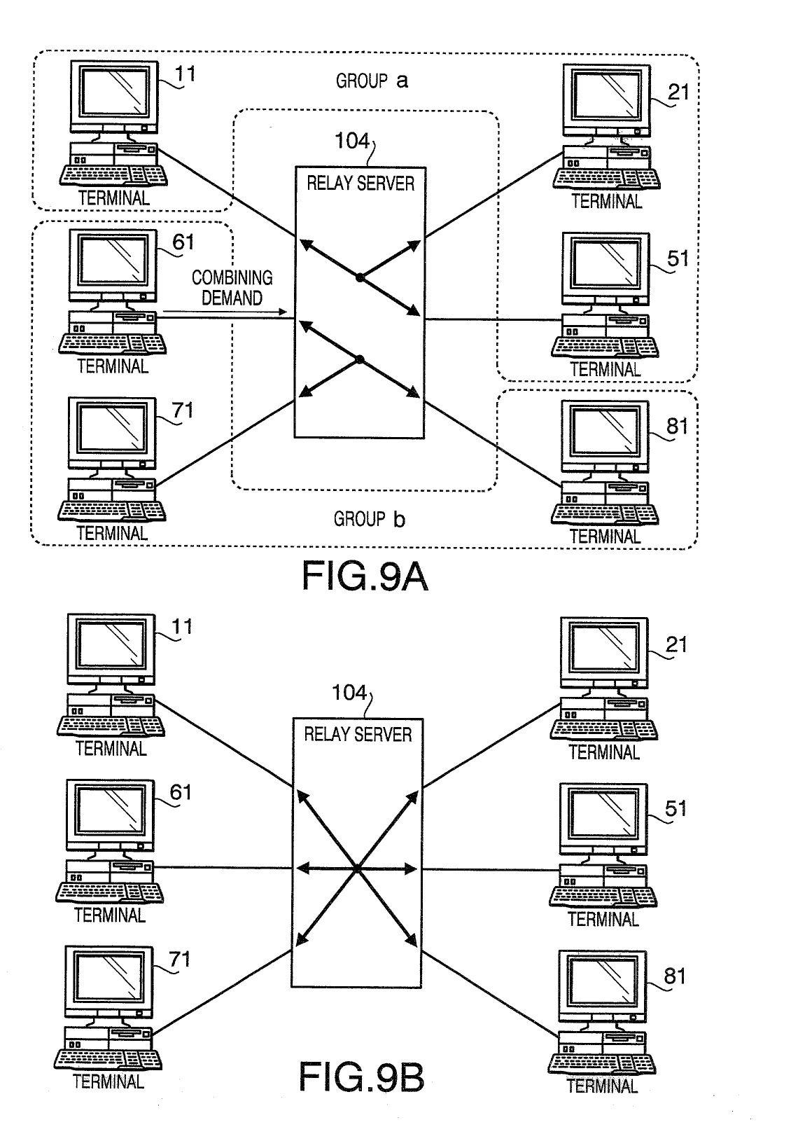

A procedure for combining groups in one example of the communication system including the second embodiment of the relay server of the present invention will be described with reference to FIGS. 9A and 9B. In FIGS. 9A and 9B, the reference numerals 71, 81 designate terminals. In the example shown in FIGS. 8A and 8B, it was shown of a case in which one network apparatus (terminal 61) participates in the group. Apart from this case, it is possible for the groups to be combined. In the example shown in FIG. 9A, the terminal 11, the terminal 21, and the terminal 51 are carrying out the communication reciprocally by the relaying of the relay server 104, and form a group (a). In addition, the terminal 61, the terminal 71, and the terminal 81 are carrying out the communication reciprocally by the relaying of the relay server 104, and form a group (b). The relay server 104 is capable of relaying each of the communication in each of a plurality of groups as in the manner stated above. Under the state shown in FIG. 9A, since the group (a) and the group (b) are carrying out the communication independently of each other, the mutual communication between the groups (a) and (b) cannot be carried out.

Under this state, the connection information of the group (a) is disclosed to at least one of the terminals of the group (b), and the demand to combine the groups is carried out from the group (b) to the group (a). In such a case, the terminal that is a member of the group (b), for example, the terminal 61, demands the searching of the connection information to the relay server 104 as in the manner stated above, and obtains various connection information including the connection information of the group (a). Then, by using the obtained connection information of the group (a), the terminal of the group (b) demands the combining with the group (a) to the relay server 104. The relay server 104 notifies the demand to combine to the group (a), and when it is approved, as shown in FIG. 9B, the group (b) combines with the group (a), and the communication can be carried out among the respective terminals within the group that is formed by the terminal 11, the terminal 21, the terminal 51, the terminal 61, the terminal 71, and the terminal 81.

Further, when demanding the combining, for example, the approval from each network apparatus within the group can be obtained, or in the case there is the network apparatus that represents the group, the origin which demands the combining can be limited such that the combining demand is carried out from the network apparatus which represents the group. Moreover, for example, in the group that received the combining demand, the approval of combining can be obtained from each network apparatus within the group, or in the case there is the network apparatus representing the group, the approval of the combining can be carried out at such a network apparatus. Moreover, in the case the number of participation in the group is limited, the combining can be rejected or the participation in the group can be carried out selectively.

Moreover, accompanying the combining of the groups, the connection information of the respective groups stored in the relay server 104 is united, but it is possible to leave any one of the keywords or the like that are registered by the respective groups, or to merge the keywords of both of the groups.

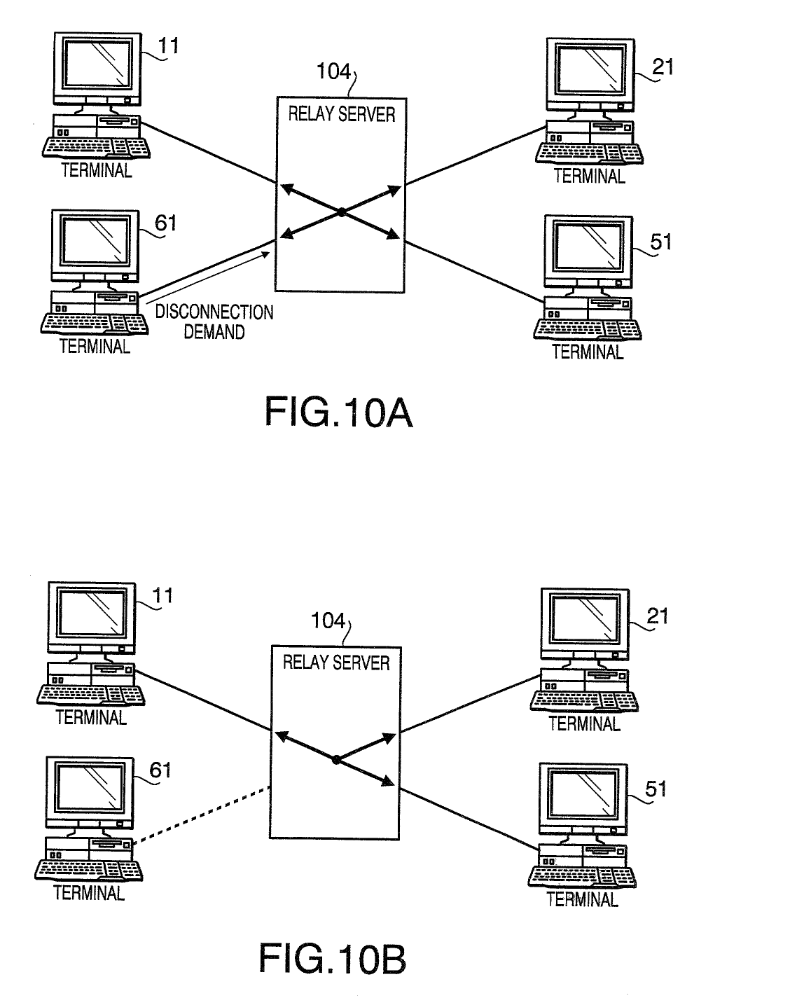

A procedure for terminating the communication with the group in one example of the communication system including the second embodiment of the relay server of the present invention will be described with reference to FIGS. 10A and 10B. As in the manner stated above, when the communication is being carried out among the network apparatus within the group, a part of the network apparatus can end the communication with the other network apparatus within the group.

In the example shown in FIG. 10A, it is shown of a state in which the communication is being carried out among four parties, i.e., the terminal 11, the terminal 21, the terminal 51, and the terminal 61. Under this state, for example, when the terminal 61 ends the communication with the group, the terminal 61 transmits, to the relay server 104, the disconnection demand for disconnecting the communication. When the relay server 104 receives the disconnection demand from the terminal 61, the relay server 104 eliminates the terminal 61 from the members of the group, and stops the relaying between the terminal 11, the terminal 21 and the terminal 51, and the terminal 61. Accordingly, as shown in FIG. 10B, the information transmitted from the terminal 11, the terminal 21, and the terminal 51 are not sent to the terminal 61. The relaying of the communication among the terminal 11, the terminal 21, and the terminal 51 is continued. Further, the TCP/IP connection between the terminal 61 and the relay server 104 can be maintained as it is, or the TCP/IP connection itself can be disconnected.

Further, the fact that the terminal 61 withdrew from the members of the group can be notified to the terminal 11, the terminal 21, and the terminal 51 that are the other members of the group. Moreover, various manners can be adopted. For example, the fact may be notified only to the network apparatus which represents the group.

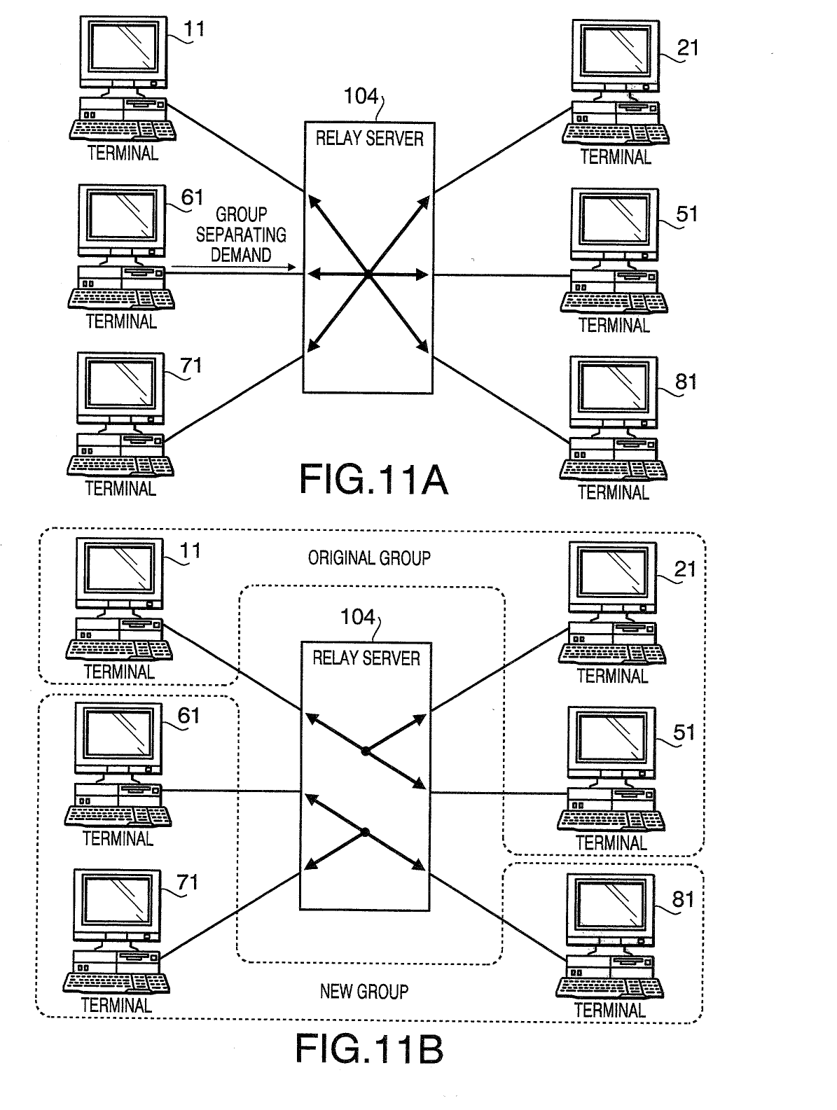

A procedure for dividing the group in one example of the communication system including the second embodiment of the relay server of the present invention will be described with reference to FIGS. 11A and 11B. In the example shown in FIGS. 10A and 10B, the network apparatus ends the communication, but a part of the network apparatus within the group can continue the communication in a different group, i.e., a group having different members or having less members while the communication is maintained among the part of the network apparatus..

In the example shown in FIG. 11A, it is shown of a case in which the communication is being carried out among six network apparatus, i.e., the terminal 11, the terminal 21, the terminal 51, the terminal 61, the terminal 71, and the terminal 81. It will be described of a case in which under this condition, for example, the terminal 61, the terminal 71, and the terminal 81 end the communication with the terminal 11, the terminal 21, and the terminal 51 while the terminal 61, the terminal 71, and the terminal 81 maintain the communication among themselves.

In such a case, the demand for dividing the group such that the terminals 61, 71, and 81 are separated from the group is transmitted to the relay server 104 by one of the terminal 61, the terminal 71, the terminal 81, for example, by the terminal 61. The relay server 104 eliminates the terminal 61, the terminal 71, and the terminal 81 from the relaying communication targets of the original group, and the information from the terminal 11, the terminal 21, and the terminal 51 are not relayed to the terminal 61, the terminal 71, and the terminal 81. Furthermore, the connection information is created with the terminal 61, the terminal 71, and the terminal 81 as the group, and the relaying of the communication among the terminal 61, the terminal 71, and the terminal 81 is continued. At this time, the information from the terminal 61, the terminal 71, and the terminal 81 are not relayed to the terminal 11, the terminal 21, and the terminal 51. Accordingly, as shown in FIG. 11B, the communication is carried out independently in each of the group formed by the terminal 11, the terminal 21, and the terminal 51, and the group formed by the terminal 61, the terminal 71, and the terminal 81.

Further, the demand for dividing the group can be carried out from one network apparatus as in the manner stated above, or can be carried out from the network apparatus that is to be a member of each of the groups. In addition, after the group is divided, the information concerning the excluded members may be notified to the network apparatus of the remaining members or to the network apparatus representing the group.

The various settings for the group that started the communication newly by the dividing demand can be copied from the group before the dividing, or the setting of the default can be applied. For example, when the keyword for specifying the group is stored as the connection information, after the dividing, the keyword of the original group can be copied, or at the time of the dividing, registration of the keyword can be accepted, or until accepting the registration, the keyword can be not applied.

As in the manner stated above, by relaying the communication by the relay server 104, the one-to-one, one-to-plural, or plural-to-plural communication can be carried out. As a result, while the communication is being carried out, for example, other network apparatus can participate or a connection can be disconnected, or the combining or the dividing of the groups or the group can be carried out.

In the case the relay server 104 has carried out the communication among a plurality of network apparatus as in the manner stated above, it is possible to maintain the connection information related to this time (i.e., the information concerning the network apparatus which have been carrying out the communication, the keyword, or various settings) even after the end of the communication. For example, the connection information can be maintained in accordance with the demand from the network apparatus which has been carrying out the communication, or the connection information can be maintained automatically.

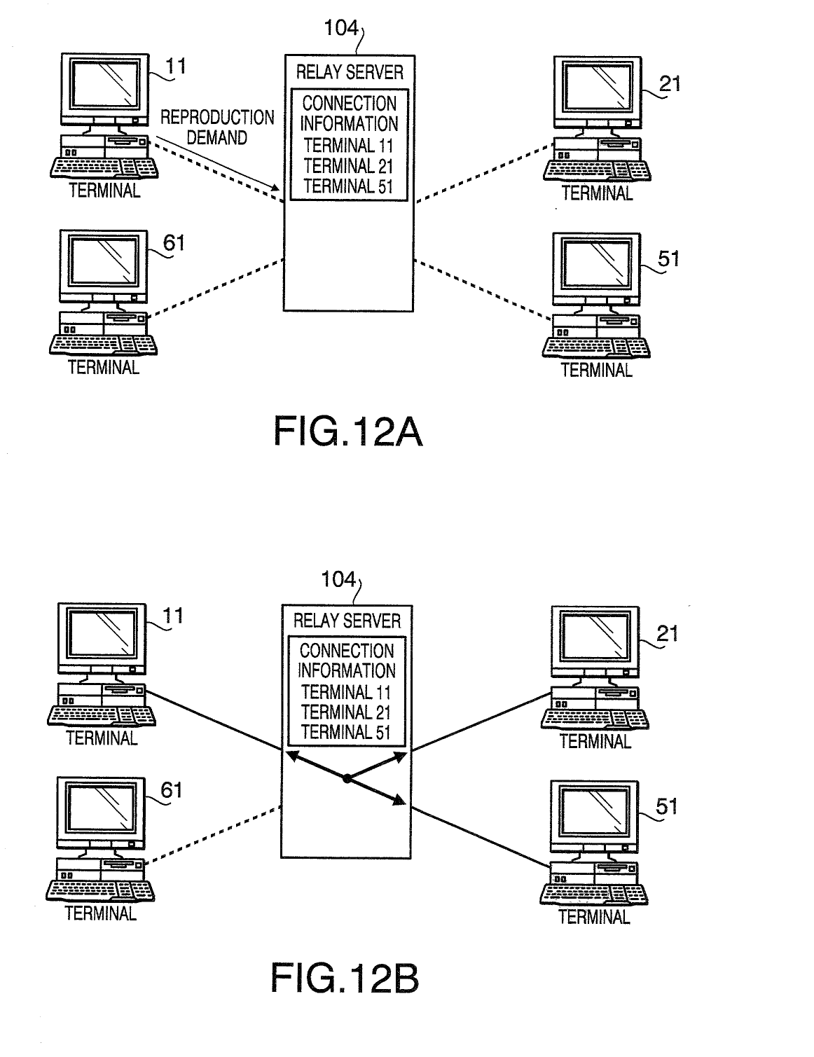

As in the manner stated above, even when the connection information related to the communication which has been done still remains even after the end of the communication, the communication can be reproduced in accordance with this connection information. A procedure for reproducing the communication in one example of the communication system including the second embodiment of the relay server of the present invention will be described with reference to FIGS. 12A and 12B. In the example shown in FIGS. 12A and 12B, it is shown of a case in which the connection information is stored in the connection information storing unit 143 of the relay server 104, and such connection information is information related to the time when the communication was carried out by the group formed by the terminal 11, the terminal 21, and the terminal 51. FIG. 12A shows an example in which the terminal 11, the terminal 21, the terminal 51, and the terminal 61 make the login to the relay server 104, and the TCP/IP connection is made.

Under this state, for example, the terminal 11 transmits, to the relay server 104, the search demand in relation to the connection information of the past, and obtains, as the search result, the connection information of the time when the communication was carried out by the group comprised of the terminal 11, the terminal 21, and the terminal 51. The terminal 11 demands, to the relay server 104, the reproduction of the communication by designating the obtained connection information. At the relay server 104, the control unit 142 takes out the designated connection information from the connection information storing unit 143, and the relay server 104 recognizes that the members of the communication which was carried out at that time are the terminal 11, the terminal 21, and the terminal 51. Subsequently, the relay server 104 transmits the connection demand to the terminal 21 and the terminal 51, and further to the terminal 11, and starts the communication with the network apparatus which permitted the communication, and the relaying between the relay server and the network apparatus of the other members. Accordingly, as shown in FIG. 12B, the communication can be carried out by the group formed with the terminal 11, the terminal 21, and the terminal 51. As in the manner stated above, it is possible to carry out the communication that was carried out among a plurality of network apparatus in the past. Moreover, the relaying is not carried out to the network apparatus that is not registered in the connection information of the past, for example, the terminal 61, even when the terminal 61 has performed the logon.

Further, when the network apparatus of the member of the group that is specified from the connection information of the past has not made the login to the relay server 104, the connection demand cannot be carried out from the relay server 104. Likewise, the connection demand cannot be carried out in the case the vacant TCP/IP connection does not exist due to the connections being carried out for the communication with other network apparatus. Furthermore, also in the case the connection demand from the relay server 104 is rejected at the network apparatus side, the communication cannot be started. In such a case, the communication based on the connection information of the past cannot be realized, and the origin that demanded the reproduction of the communication of the past can be notified that the reproduction cannot be made to full extent. Alternatively, the relay server, the network apparatus, or/and the like may be constructed so as to reproduce the communication only in the case the reproduction can be made to a full extent, and or constructed so as to select one from these cases.

As in the manner stated above, the relay server 104 relays the communication with a plurality of network apparatus, and the communication can be realized among the network apparatus. However, depending on the communication band in the communication unit 141 or the processing ability of the control unit 142, there are cases in which the delay occurs in the relaying of the forwarding data. In such a case, for example, priority can be provided such that the communication with a specific network apparatus is to be provided with priority, and the communication with high priority can be relayed before other communication. For example, the priority is set high on the application protocol communication or the like that is necessary to be carried out in real time, such as the communication of a moving image (an animated image), thereby, wide communication band can be secured, and the communication can be carried out without losing the characteristic of the real time.

The examples described hereinabove of the communication among the network apparatus which have made the login to one relay server 104. However, the present invention is not limited to such a case. For example, a plurality of relay servers can be provided, and the communication can be carried out likewise among the network apparatus which have made the login to different relay servers. Of course, a group can be formed by a plurality of network apparatus which have made the login to a plurality of different relay servers such that the communication can be carried out reciprocally, and the participation in the group, disconnection of the communication with the group, and/or the combining or the dividing of the groups can be carried out. In addition, the relay servers, network apparatus, and/or the communication system may be constructed such that the connection information can be held by each of the relay servers, and one relay server asks another relay server or other relay servers about the connection information at the time of the searching, and/or may be constructed such that the connection information can be forwarded among the relay servers reciprocally so as to realize the consistency of the connection information at all times. A server for holding and searching for the connection information can be provided separately, and can be constructed to store the connection information in the server, and the search demand of the connection information can be requested to the server.

What is claimed is:

1. A relay server comprising:
communication means capable of carrying out communication with each of a plurality of network apparatus respectively by using at least one connection; and
control means for relaying the communication between the network apparatus,
wherein the control means manages the at least one connection by using a connection identifier which makes it possible to uniquely identify each of the at least one connection which the communication means uses for communication with the each of the plurality of network apparatus.

2. The relay server according to claim 1, wherein the each of the plurality of network apparatus makes login to the relay server to establish the at least one connection before the communication with the each of plurality of network apparatus is carried out, and until the communication is carried out, the at least one connection is maintained.

3. A relay server comprising:
communication means capable of carrying out communication with each of a plurality of network apparatus respectively by using at least one connection, and carrying out communication with another relay server or other relay servers existing on the Internet; and
control means for relaying the communication between the network apparatus or between the network apparatus and the another relay server or the other relay servers by using the communication means,
wherein the control means manages each of the at least one connection which the communication means respectively uses for communication with the each of the plurality of network apparatus, by using a connection identifier which makes it possible to uniquely identify the each of the at least one connection and the connections which the communication means uses for communication with another relay server or other relay servers.

4. The relay server according to claim 3, wherein the connection identifier is created so as to include a relay server identifier corresponding to each of the relay server and the another relay server or the other relay servers.

5. The relay server according to claim 4, wherein the connection identifier further includes a user ID of the network apparatus connected to the each of the relay server and the another relay server or the other relay servers.

6. The relay server according to claim 5, wherein the connection identifier further includes a connection number corresponding to each connection with the network apparatus having the user ID.

7. The relay server according to claim 3, wherein the control means obtains a part of the connection identifier via the communication means from a database server existing on the Internet.

8. The relay sever according to claim 1 or 3, wherein the control means sends back, to one of the plurality of network apparatus, the connection identifier corresponding to login from the one network apparatus when the one network apparatus makes the login to the relay server.

9. A relay server comprising:
communication means capable of carrying out communication with a plurality of network apparatus;
control means for relaying the communication among the plurality of network apparatus; and
storing means for storing connection information concerning the network apparatus for which the control means is relaying the communication,
wherein when the control means receives inquiry about connection condition via the communication means, the control means sends back the connection information stored in the storing means as a reply to the inquiry.

10. The relay server according to claim 9, wherein the control means receives the inquiry about the connection condition of a specified network apparatus of the plurality of network apparatus.

11. The relay server according to claim 9, wherein the storing means stores, as the connection information, information indicating a group comprised of at least a part of the plurality of network apparatus for which the control means is relaying the communication.

12. The relay server according to claim 9, wherein when the control means receives a demand for searching for the connection information, the control means searches for the connection information stored in the storing means to send back the connection information as the reply to the inquiry.

13. The relay server according to claim 9, wherein the control means receives, from one of the plurality of network apparatus, indication information which indicates how to deal with the inquiry in advance, and when the control means receives the inquiry about the connection information, the control means determines whether or not to send back the connection information as the reply to the inquiry, in accordance with the indication information.

14. The relay server according to claim 9, wherein the control means receives, from at least one network apparatus of the plurality of network apparatus which is not a member of a group, a demand for participating in said group comprised of at least a part of the plurality of network apparatus, and the control means relays communication between the at least one network apparatus and said group.

15. The relay server according to claim 9, wherein the control means combines a plurality of groups comprised of the plurality of network apparatus so as to form one group, and then relays communication among the plurality of network apparatus belonging to the formed one group.

16. The relay server according to claim 14 or 15, wherein the control means can limit a number of network apparatus which belong to the group.

17. The relay server according to claim 9, wherein by following a demand, the control means divides one or more network apparatus from a group comprised of at least a part of the plurality of network apparatus for which the relay server is relaying communication.

18. The relay server according to claim 9, wherein even after relaying of the communication by the control means is ended, the storing means holds the connection information concerning the communication whose relaying has been ended, and by following a demand, the control means reproduces the relaying of the communication in accordance with the connection information held by the storing means.

19. The relay server according to claim 18, wherein the control means receives the demand for reproducing the communication in accordance with the connection information which has been specified, and reproduces the relaying of the communication in accordance with the specified connection information.

20. The relay server according to claim 9, wherein the control means gives priority to the communication with at least one network apparatus of the plurality of network apparatus so as to ensure bandwidth in accordance with necessity.
